(19) United States
(12) Patent Application Publication
(10) Pub. No.: US 2012/0024983 A1
(43) Pub. Date: Feb. 2, 2012

(54) Liquid Dispensing System

(75) Inventor: Wim Engelen, Vilvoorde (BE)

(73) Assignee: MONSANTO EUROPE N.V., Antwerp (BE)

(21) Appl. No.: 13/262,318

(22) PCT Filed: Mar. 29, 2010
(86) PCT No.: PCT/EP10/54116

§ 371 Date: Sep. 30, 2011

(30) Foreign Application Priority Data
Mar. 31, 2009 (EP) 09004645.9

(51) Int. Cl. B05B 9/043; B05B 11/02; B05B 1/30; B05B 9/01

(52) U.S. Cl. 239/353; 239/349; 239/354; 239/571

(57) ABSTRACT

The current invention relates to a dispenser for liquid products comprising a removable liquid holding reservoir, an essentially rigid chamber for holding liquid under pressure and comprising a spring and a piston to place liquid injected into the chamber under pressure, a pump arrangement for pumping liquid from the liquid holding reservoir into the chamber for holding liquid under pressure, the pump being connected to the chamber through a one-way valve preventing liquid to flow from the chamber back into the pump arrangement, the chamber being connected to a spray nozzle through a valve controllable by the user for spraying the liquid.

### FIELD OF THE INVENTION

The present invention relates to an easy to use dispenser for liquid products, comprising a liquid holding reservoir connectable to a chamber for holding liquid under pressure and in turn connected to a spray arrangement for spraying the relevant liquid. The system of the invention is intended for the spraying of liquids selected from pesticides, such as herbicides, insecticides, fungicides, and others, house-hold cleaning products including for instance detergents, window cleaning products, carpet cleaning products or similar.

### BACKGROUND OF THE INVENTION

Dispensers are generally well known in the art. Prior art dispensers of the general type typically include a bottle and a dispensing mechanism, for instance a trigger sprayer. The trigger sprayer may be attached to the bottle in any conventional way, e.g. by a threaded connection, a bayonet connection or a snap connection. Such trigger sprayers are well known in the art.

A problem with such dispensers is that those containers, when completely filled or filled to a substantial extent, are mostly uncomfortable to use as a result of the weight of the liquid contained therein. Also, most of these dispensers are intended to be used once and thrown in the waste when empty.

In the light of environmental concerns and also for reasons of cost reductions, reusable spray equipments have been proposed that can be connected to different containers or refill packs. Some others can be (re)loaded with diluted concentrates from refill packs or with ready-to-use liquids from refill packs, preferably environmentally friendly refill packs.

Known dispensers include squeeze bottles made of a rather flexible material and connected to a spray nozzle. The liquid contained in the bottle is pressurized by the squeezing of the bottle and liquid is released through the nozzle. Such arrangement is very simple and of low cost but leads to irregular spray patterns and leakage.

In the alternative, the liquid containing bottle is a more rigid bottle and pressurized by pumping air into it. The liquid under pressure then may be released through the sprayer. Here again, the spray pattern is not constant as it changes along with pressure reduction in the bottle in the course of use. Also, these equipments are generally rather heavy and inconvenient to use.

Another alternative is to mount a re-usable spray arrangement that includes a trigger sprayer on refill packs. In such cases, the refill packs need to comprise appropriate connection means and be of the appropriate shape, thus of relatively high cost and more likely to be less environmentally friendly than one-way refill packs. Such arrangements comprising trigger sprayers further require the user to accomplish inconvenient pumping actions with his or her finger and the spray volume per pumping movement is rather small, mostly around 1 ml.

EP-0814913 discloses a pump sprayer apparatus intended for being mounted on a liquid supply container suitable to contain pesticides, detergents or other liquid chemical compositions. The sprayer apparatus comprises a pump assembly, such as a positive displacement pump with a piston reciprocally movable in a cylinder, an inflatable accumulating bladder and a dispensing assembly. The piston raised by the user draws liquid from the supply container into the cylinder and then, when movement is reversed, pushes the said liquid into the inflatable bladder which accumulates the liquid under pressure. The energy accumulated into the expanded bladder may then be transferred to the liquid in an essentially constant manner when released from the bladder for discharge through the sprayer. One of the disadvantages of that system though is that it needs to be combined with a rather rigid supply container. In addition, the volume of the liquid ready to be dispensed through the sprayer is relatively small, thus allowing for a reduced number of sprays.

### OBJECTS OF THE INVENTION

The present invention now seeks to provide a dispenser for liquid products selected from pesticides, such as herbicides, insecticides, fungicides, and others, house-hold cleaning products including for instance detergents, window cleaning products, carpet cleaning products or similar.

It is desired that the invention dispenser is easy to operate and of convenient use, while allowing for a comfortable spray volume prior to each recharging (in other words showing higher autonomy), more specifically adapted to the relevant use of the equipment.

It should advantageously be reusable by disconnection from the liquid holding reservoir and reconnection to a refill liquid holding reservoir.

Further objects and advantages will appear from the description herein.

### SUMMARY OF THE INVENTION

The dispenser of the invention for liquid products comprises
a removable liquid holding reservoir,
an essentially rigid chamber for holding liquid under pressure and comprising a spring and a piston to place liquid injected into said chamber under pressure,
a pump arrangement for pumping liquid from the liquid holding reservoir into the said chamber for holding liquid under pressure,
the pump being connected to the chamber through a one-way valve preventing liquid to flow from the chamber back into the pump arrangement
the chamber being connected to a spray nozzle through a valve controllable by the user for spraying said liquid.

Advantageously, the liquid holding reservoir may be a flexible, one-way refill pack. It may be connected to the pump arrangement by a flexible tube and a one-way valve that allows flow of liquid solely from the reservoir to the pump, thus avoiding liquid to escape from the pump. Or the pump arrangement can be connected directly to a one-way valve/closure on the liquid holding reservoir.

In a preferred embodiment, the pump arrangement comprises a cylinder of essentially circular section, one end of which is connectable to the liquid holding reservoir through a one-way valve that allows flow of liquid solely from the reservoir to the pump, and is further connected to the chamber through a one-way valve preventing liquid to flow from the chamber back into the pump cylinder, and a piston slidably mounted in the cylinder in a liquid tight manner, the piston being assembled with a rod extending through the opposite end of the cylinder into a handle for operation by the user.

Further embodiments and variations will become apparent from the description and drawings following hereafter.

### SHORT DESCRIPTION OF THE DRAWINGS

The invention will now be illustrated with reference to the annexed drawings:

FIG. 1 is a schematic side view of the invention dispenser in an upright position;

FIG. 2 is a schematic view of a cross section along a longitudinal plane;

FIG. 3 is a top plane view of the dispenser of FIG. 1;

FIG. 4 is a schematic side view analogous to the view of FIG. 1, showing different positions of movable parts;

FIG. 5 is a perspective view of a different embodiment of the invention;

FIG. 6 is a schematic view of a longitudinal cross-section of the embodiment of FIG. 5.

FIG. 7 is a schematic view of the arrangement of the valves, as well as of the flow of liquid between the individual elements of the invention dispenser;

FIGS. 8A and 8B are exploded views from the top of the embodiment of FIGS. 1-4, the casing having been omitted; and

FIGS. 8C and 8D are partial side views of the same embodiment as represented in FIGS. 8A and B, the casing being omitted in order to better represent schematically the internal connections.

### DETAILED DESCRIPTION OF THE INVENTION

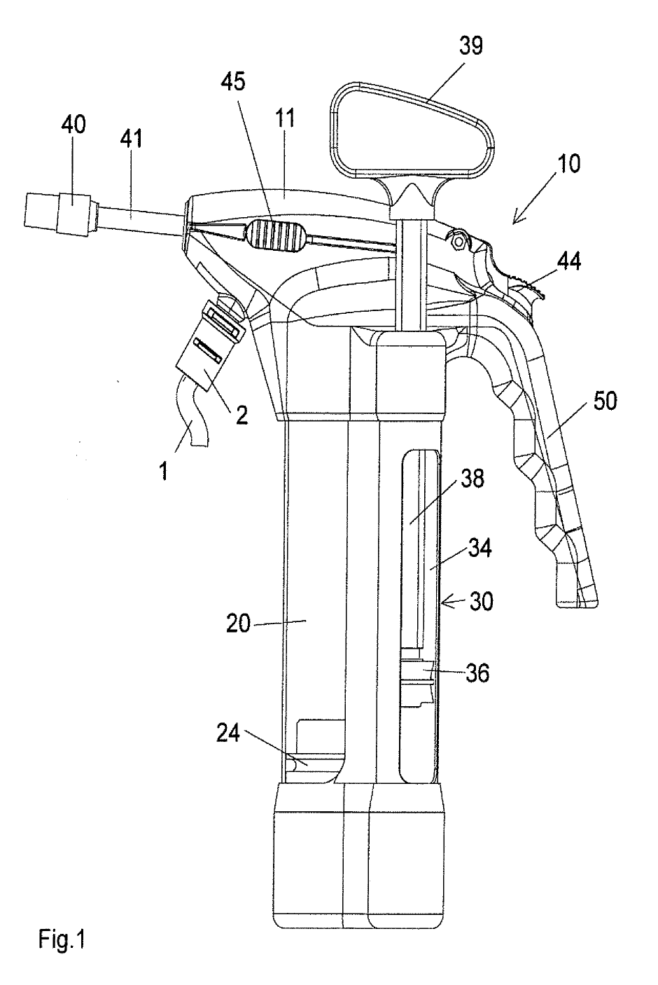

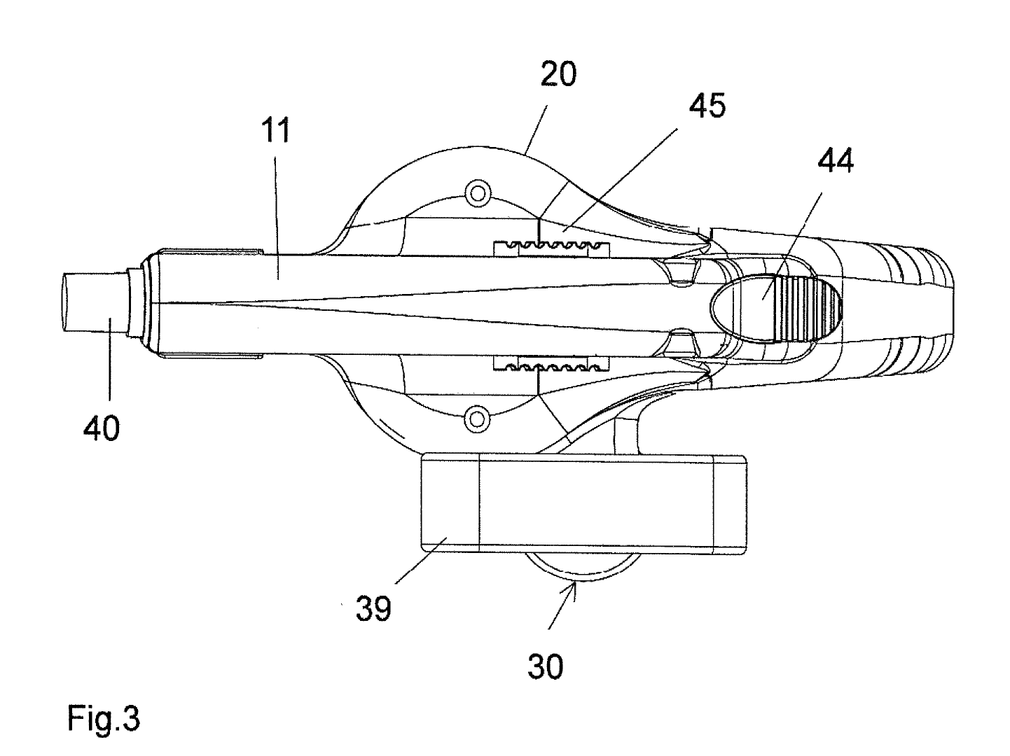

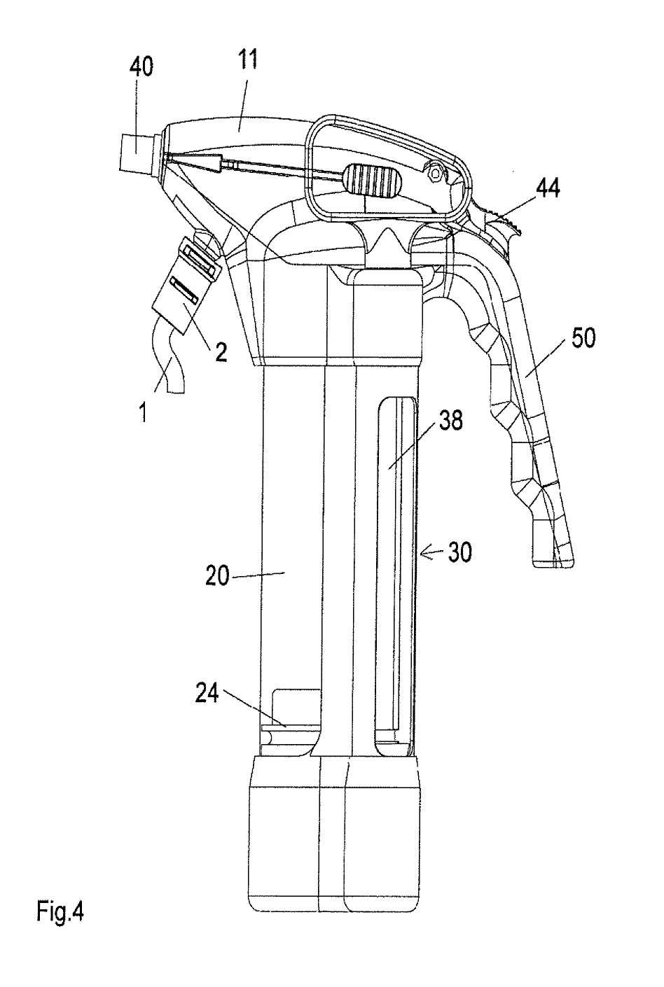

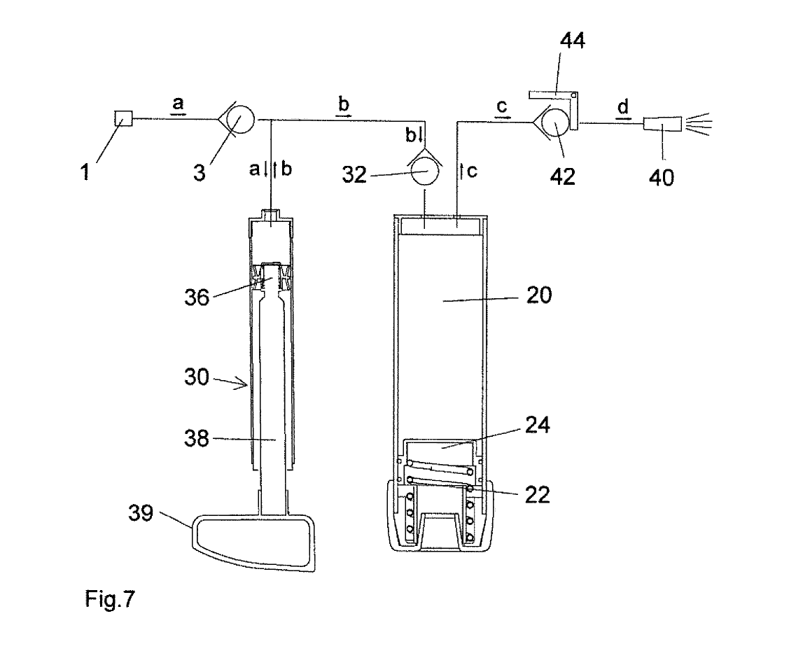

In the figures for a same embodiment, same reference numerals refer to the same element. The dispenser represented schematically in FIGS. 1 to 4 constitutes a first embodiment of the invention. The dispenser 10 comprises a removable liquid holding reservoir (not represented) that can be connected to it under 2 by way of a flexible tube 1, an essentially rigid chamber 20 for holding liquid under pressure and comprising a spring 22 acting on a piston 24 arranged at the bottom of the cylinder to place liquid injected into said chamber 20 under pressure, a pump arrangement 30 for pumping liquid from the liquid holding reservoir (not represented) into the said chamber 20 for holding liquid under pressure, the pump 30 being connected to the chamber 20 through a conduct 32 which incorporates a one-way valve (see description with respect of FIG. 7 herein below), thus preventing liquid to flow from the chamber under pressure 20 back into the pump arrangement 30. The chamber 20 is in turn connected to a spray nozzle 40 through a valve 42 controllable by the user by exerting pressure on a trigger button 44 for spraying said liquid stored in chamber 20. The flexible tube connection 2 may advantageously be arranged at the top of the chamber 20, preferably right underneath the nozzle 40. In the alternative, the spring and the piston may be arranged at the top of the chamber 20 and the tube connector 2 is arranged at the bottom thereof.

In the case of a direct connection to the liquid holding reservoir, thus without flexible tube, this connector may also be placed at a location at the bottom of the chamber 20 or at the bottom of the handle.

The connector 2 may include the one-way valve 3 allowing liquid to flow from the external container to the pump 30 and preventing liquid to flow back into the liquid holding reservoir.

The dispenser 10 may advantageously be equipped with a handle 50 designed in such a way so as to facilitate holding of the device and spraying on target surface in ergonomically advantageous position or inclination. More specifically in the case of a dispenser of pesticides intended to be sprayed on target pests, such as weeds, the handle 50 may be inclined such as to ease directing the whole device loaded with liquid in a downward position.

The pump arrangement 30 comprises a cylinder 34 with a piston 36 of essentially circular section. One end of cylinder 34 is connectable to the liquid holding reservoir through a one-way valve 3 that allows flow of liquid solely from the reservoir to the pump 30, and is further connected to the chamber 20 through a one-way valve 32 preventing liquid to flow from the chamber 20 back into the pump cylinder 34. The piston 36 is slidably mounted in the cylinder 34 in a liquid tight manner, and is assembled with a rod 38 extending through the top end of the cylinder 30 into a handle 39 for operation by the user. According to the represented embodiment, the pump is arranged in an essentially parallel fashion to the cylindrical chamber 20 and adjacent to it. The handle 39 is arranged at the top of the dispenser or, expressed differently, at the same side as the spray nozzle 40.

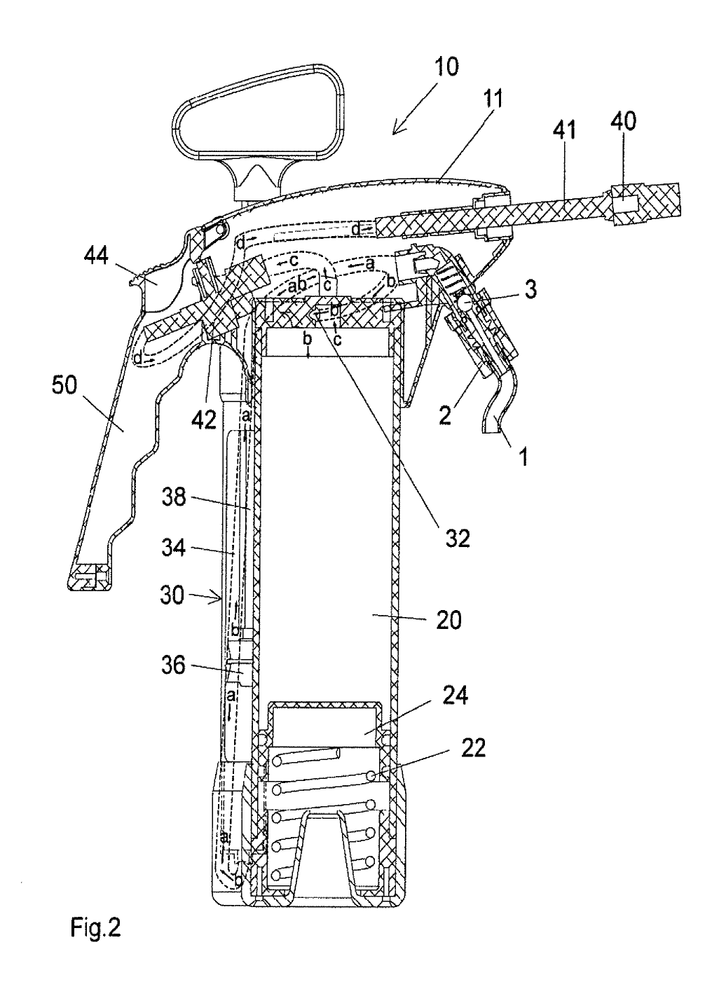

When lifting the handle 39 and hence piston 36 (see FIG. 1), the user generates a depression in the cylinder 30 and liquid is extracted from the liquid holding reservoir into cylinder 30, see FIGS. 2 and 7, following flow direction a. When pushing the handle 39 back down, the liquid stored in the cylinder 30 is expelled under pressure into the chamber 20, through connections following flow direction b. The pressure of the liquid pushes piston 24 down, thus compressing the spring 22. The energy stored in the spring allows to maintain the liquid under an essentially constant pressure in the chamber 20. The user may repeat the same operation several times until the chamber 20 is essentially full. One may then disconnect the device 10 from the liquid holding container for instance by unscrewing or unplugging tube 1 at its connection 2 with the dispenser, and use the dispenser to apply the liquid as appropriate. FIG. 7 schematically represents the flow of liquid and shows the operation of the one-way valves. When generating a depression in the pump cylinder 38, one-way valve 3 opens to allow flow of liquid from the liquid holding reservoir 1 into the pump cylinder according to flow direction a. One-way valve 32 is closed by the depression. When expelling the liquid with the pump piston 36 according to flow direction b, valve 3 closes because of the pressure acting on the side of the pump but one-way valve 32 opens and allows flow of liquid into chamber 20 where said liquid is maintained under pressure. When releasing valve 42, liquid under pressure may escape along direction c and finally d through nozzle 40.

Chamber 20 may be designed to contain an adequate volume, thus giving the dispenser a reasonable autonomy. In the case of use for pesticide application, more specifically herbicide application, a volume of approximately 200 to 600 ml is advantageous. The volume of the pump arrangement 30, i.e. cylinder 34, is preferably adapted to the volume of the chamber 20, in order for the user to fill chamber 20 after preferably 4-10 pumping operations.

One of the advantages of the invention arrangement is that the liquid to be sprayed is maintained in chamber 20 under an essentially constant pressure, thus allowing the user to preserve an essentially equal spray pattern all along the spraying operation.

Another advantage of the invention consists in the fact that the user bears a relatively light equipment with reasonable autonomy. Refill packs may be provided that are more environmentally friendly and need not consist in rigid containers. The invention equipment allows to conceive a liquid holding container for instance made of a flexible plastic bag with a rather small connection for tube 1. Several volumes may be provided for, e.g. 1 l, 2 l, 5 l and more. Such containers may be filled with so-called ready-to-use spray solution. One may also provide for containers partially filled with a concentrate and that allow top-up with water or other diluents, thus allowing for reduced transportation costs and energy resources.

Nozzle 40 may advantageously be mounted on an essentially rigid tube also called lance 41 which in turn is advantageously slidably mounted in casing 11. In addition, grips 45 may be fastened to the lance, advantageously on both sides thereof, and extend through casing 11 in order to facilitate the sliding of said lance 41.

In a particularly preferred embodiment, the grips 45 interact with trigger button 44 in order to provide a child-safety arrangement. When nozzle 40 and thus grips 45 are in retracted position, said grips may block movement of the trigger button 44 and thus prevent opening of the release valve 42. When sliding said grips outwardly in order to expend the lance 41, the trigger button 44 is released and may be operated as appropriate in order to release liquid through the spray nozzle 40.

Even more preferred, an additional child-resistance may be provided, such that preferably both grips 45 are in the form of a click assembly that snap into a counterpart on casing 11 in several (intermediate) locked positions of the lance 41 and that require pressure on one part of each grip 45 or a squeezing action to slightly buckle the relevant grips 45 or their link to the lance 41 in order to release said click assembly.

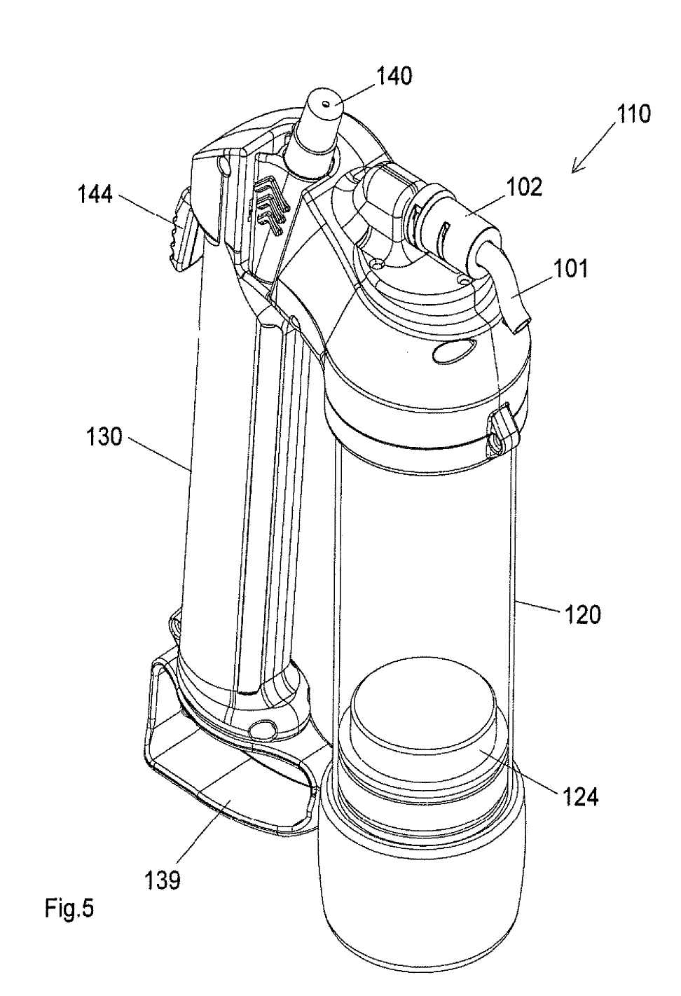

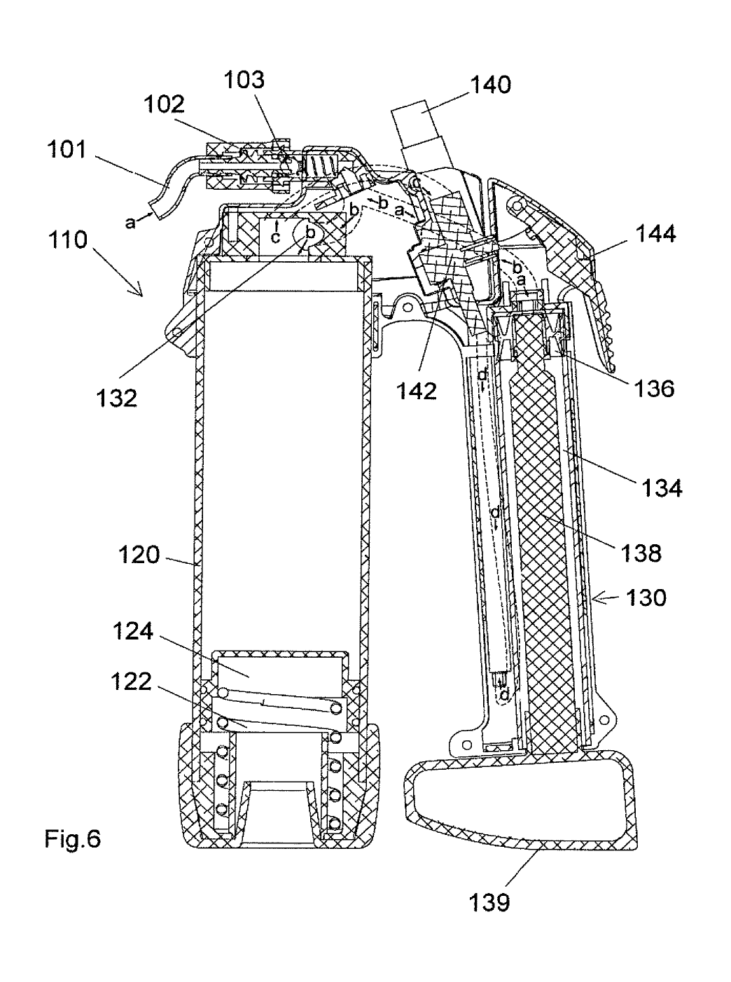

FIGS. 5 and 6 now represent a different embodiment of the invention. While the individual elements are essentially the same, they are assembled in a slightly different arrangement. The dispenser 110 comprises a removable liquid holding reservoir (not represented) that can be connected to it by way of a flexible tube 101, an essentially rigid chamber 120 for holding liquid under pressure and comprising a spring 122 acting on a piston 124 to place liquid injected into said chamber 120 under pressure, a pump arrangement 130 for pumping liquid from the liquid holding reservoir (not represented) into the said chamber 120 for holding liquid under pressure, the pump 130 being connected to the chamber 120 through a conduct which incorporates a one-way valve, thus preventing liquid to flow from the chamber under pressure 120 back into the pump arrangement 130. Here too, the chamber 120 is in turn connected to a spray nozzle 140 through a release valve 142 controllable by the user by exerting pressure on a trigger button 144 for spraying said liquid stored in chamber 120. In the advantageous embodiment of FIGS. 5 and 6, the pump 130 is arranged in the form of a handle slightly inclined compared to the axis of the cylindrical chamber 120 and detached from it, while connected at the top end to the chamber 120 and the handle 139 extending through the opposite end of the pump. The tube connector 102 is then preferably arranged at the top of the cylindrical chamber 120. The nozzle 140 then is arranged at the top of the pump, right next to the connector 102. The dispenser 110 does not need a separate handle as the pump arrangement 130 is in the form of a handle already. The inclination of pump arrangement 130 and possibly of the spray nozzle 140 both compared to the axis of the essentially cylindrical chamber 120 may be designed in such a way so as to facilitate holding of the device and spraying on target surface in ergonomically advantageous position or inclination. More specifically in the case of a dispenser of pesticides intended to be sprayed on target pests, such as weeds, the inclination will be such as to ease directing the whole device loaded with liquid in a downward position.

As mentioned in relation to the embodiment described above, one may also provide for a direct connection between the liquid holding reservoir and the pump. In such a case, the connector 102 may be arranged at the bottom of the chamber 120 or at the bottom of the handle.

Contrary to the embodiment of FIGS. 1 to 4, the embodiment of FIGS. 5 and 6 does not allow pumping operation when resting in upright position on a surface. Handle 139 needs to be pulled out downwardly to generate a depression in the pump for extracting liquid from the liquid holding reservoir. Pushing the handle 139 back into the handle pushes the liquid into chamber 120. The pressure of the liquid pushes piston 124 down, thus compressing the spring 122. The energy stored in the spring allows to maintain the liquid under an essentially constant pressure in the chamber 120. The user may repeat the same operation several times until the chamber 120 is essentially full. One may then disconnect the device 110 from the liquid holding reservoir for instance by unscrewing or unplugging tube 101 at its connection 102 with the dispenser, and use the dispenser to apply the liquid as appropriate.

One of the advantages of the embodiment shown in FIGS. 5 and 6 is that the nozzle 140 bearing lance may be longer as it may easily be arranged in parallel to either the pump 130 or chamber 120. The connecting tube schematically represented with flow direction d then needs to extend up to the end of the lance opposite nozzle 140.

The internal connections are essentially the same as per the embodiment of FIGS. 1-4. As can be seen from FIG. 6, liquid is extracted from the liquid holding reservoir through tube 101 and its connection to the pump cylinder 134 following direction a; it may then be expelled through tubular connections following direction b, into chamber 120. Opening of the release valve 142 then finally allows liquid to escape passing through tubular connections c and d, as schematically represented in FIG. 6.

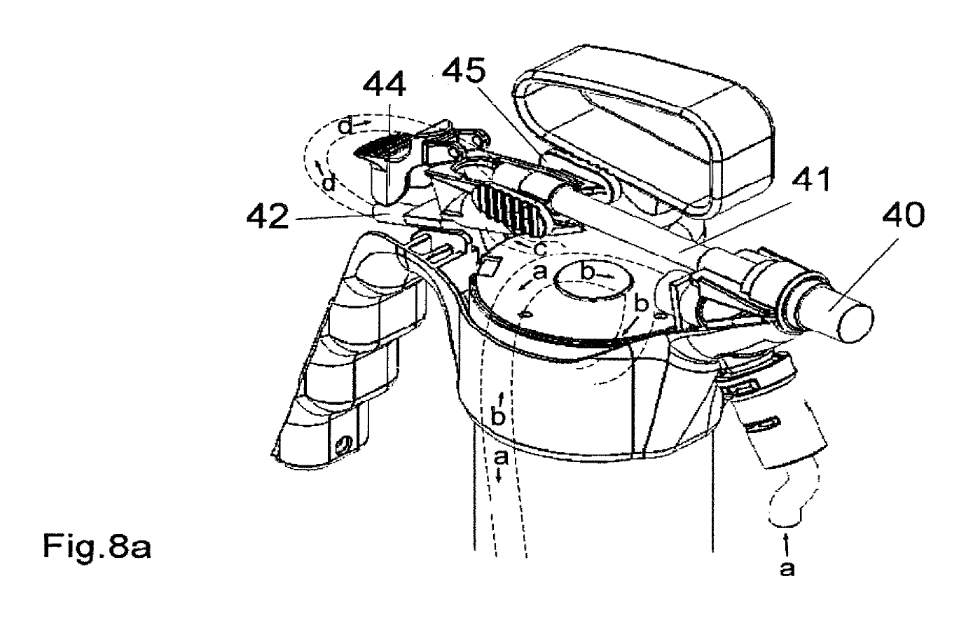

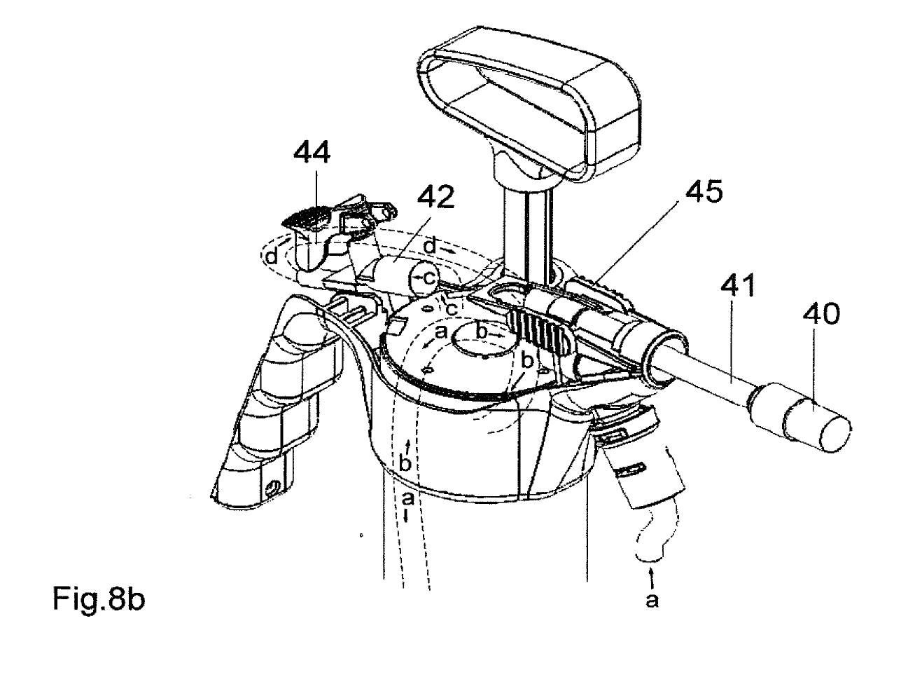

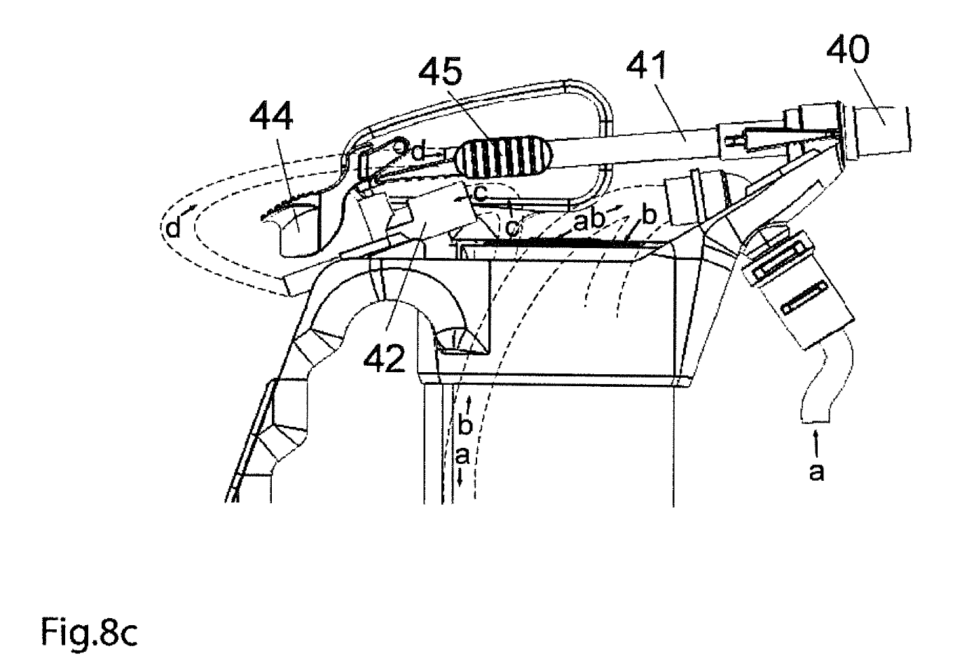

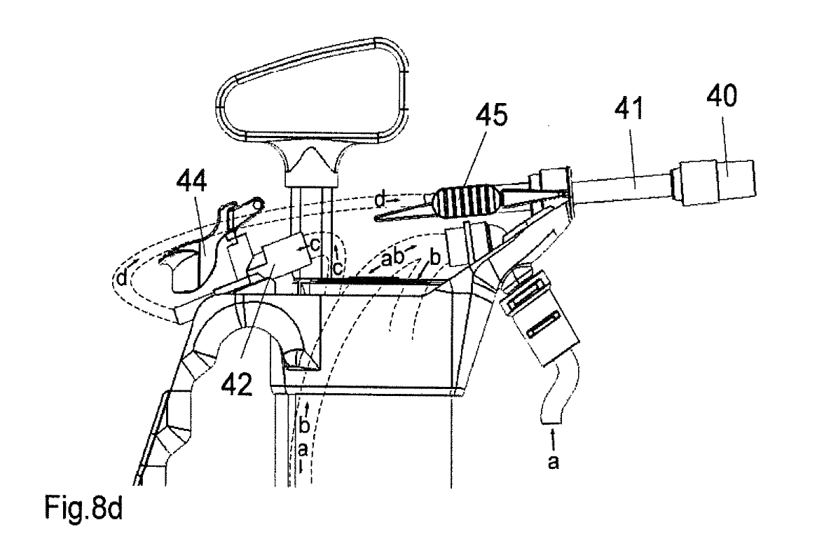

Turning now to FIGS. 8A and 8C, nozzle 40 bearing lance 41 is shown in retracted position, blocking with corresponding grips 45, and possibly an extension thereof, the movement of trigger button 44, thus preventing release of spray liquid through release valve 42. In order to better show the interaction of grips 45 with button 44, the casing of the device has been omitted from the drawing. The tubular connection (d) is shown in a schematic way. In FIGS. 8B and 8D, the nozzle 40 bearing lance 41 has been shown in extended position, the grips thus liberating button 44 which may thus be operated to spray liquid. As already mentioned, the grips 45 slide in the casing which has been omitted for the sake of clarity.

1. A dispenser for liquid products comprising:
an essentially rigid chamber for holding liquid under pressure and comprising a spring and a piston to place liquid injected into the chamber under pressure,
a pump arrangement for pumping liquid from a removable liquid holding reservoir into the chamber for holding liquid under pressure,
the pump being connected to the chamber through a one-way valve preventing liquid to flow from the chamber back into the pump arrangement; and
the chamber being connected to a spray nozzle through a valve controllable by the user for spraying said liquid.

2. The dispenser of claim 1 wherein the liquid holding reservoir is a flexible one-way refill pack.

3. The dispenser of claim 1 wherein the liquid holding reservoir is connectable to the pump arrangement by a flexible tube and a one-way valve that allows flow of liquid solely from the reservoir to the pump.

4. The dispenser of claim 3 wherein the one-way valve is arranged in a connector.

5. The dispenser of claim 1 wherein the pump arrangement comprises a cylinder of essentially circular section, one end of which is connectable to the liquid holding reservoir through a one-way valve that allows flow of liquid solely from the reservoir to the pump, and is further connected to the chamber through the one-way valve preventing liquid to flow from the chamber back into the pump cylinder, and a piston slidably mounted in the cylinder in a liquid tight manner, the piston being assembled with a rod extending through the opposite end of the cylinder into a handle for operation by the user.

6. The dispenser of claim 1 wherein the piston and the spring are arranged at the bottom of the chamber.

7. The dispenser of claim 5 wherein the pump cylinder is arranged essentially parallel to the axis of the chamber and adjacent to it.

8. The dispenser of claim 5 wherein the pump cylinder is separate from the chamber and inclined compared to the axis of the chamber.

9. The dispenser of claim 8 wherein the piston is arranged at the top of the pump and is connected to the rod extending into the handle through the bottom end of the pump.

10. The dispenser according to claim 8 wherein the pump is assembled to the chamber at the top of the arrangement.

11. The dispenser according to claim 10 wherein the top of the arrangement comprises a tube connector, the spray nozzle and a trigger button.

12. The dispenser according to claim 1 wherein the nozzle is mounted on an essentially rigid tube or lance which is slidably mounted in a casing.

13. The dispenser according to claim 12 further comprising two opposite grips solid with the lance and extending through the casing.

14. The dispenser according to claim 13 wherein the grips interact with a release button to constitute a child-resistant assembly.

15. The dispenser according to claim 14 wherein the grips are in the form of a click assembly snapping into a counterpart on the casing in several (intermediate) locked positions of the lance, and releasable by pressure on one part of each grip or by squeezing action.
